(19) United States
(12) Patent Application Publication
(10) Pub. No.: US 2008/0204469 A1
(43) Pub. Date: Aug. 28, 2008

(54) Color Transformation Luminance Correction Method and Device

(75) Inventor: Cornelis Antoine Maria Jaspers, Hapert (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/913,694

(22) PCT Filed: May 2, 2006
(86) PCT No.: PCT/IB06/51373

§ 371 Date: Nov. 6, 2007

(30) Foreign Application Priority Data
May 10, 2005 (EP) 05103881.8

(51) Int. Cl. G09G 5/02

(52) U.S. Cl. 345/589

(57) ABSTRACT

The method of color correction in a luminance direction, comprises: applying a color transformation (T) to an input color (Ci), yielding a transformed color (Ct); determining a scaling factor (f) on the basis of a first display driving value representation (Rs5Gs5Bs) of the input color (Ci) and a second display driving value representation (Rt5Gt5Bt) of the transformed color (Ct); and multiplying a color representation of the transformed color (Ct) with the scaling factor (f) to obtain an output color (Co). It can be used to mitigate luminance errors introduced by the transformation (T).

The invention relates to a method of color correction in a luminance direction, which is an operation in the field of color processing.

The invention also relates to a device for color correction in a luminance direction and a television signal receiver comprising such a device.

The invention also relates to a computer program product realization of the essential steps of the method, for application in or cooperating with a software-enabled image processing system.

It is long since known that colors can be represented in a number of ways. There are device independent (generic) color spaces, such as CIE XYZ. There are also device dependent spaces, such as e.g. RGB space, for a typical EBU compliant CRT-based television receiver.

A camera is a variable device (e.g. its color filters, its image capturing device, its tunable parameters, . . . ), which hence also produces a device dependent color description. It is tacitly assumed however, that the camera produces RGB color representations which lead to reasonably accurate reproductions on a typical intended (“standard”) display, which can be checked e.g. with a MacBeth color checker.

The basic standards of television colorimetry (e.g. NTSC and PAL, from which concepts were transferred to e.g. MPEG-2) were developed in the 1950s, having the displays from that time in mind.

Nowadays CRT displays have totally different phosphors, but more severe, a number of novel display technologies have been introduced for television viewing, such as LCD, PDP (Plasma display panel), and in the future e.g. electronic ink displays for mobile/portable viewers.

This means that a single RGB representation of a color will lead to a different actually reproduced color on different displays, which is not what is desired.

E.g., an LCD typically has a more pale and greenish blue color than a CRT, so e.g. an RGB color of [0,0,1] may look very different on the two displays. This may not yet be objectionable to the average viewer for most colors (as color vision is actually very complex in the human brain), but for some critical colors it may be undesirable (e.g. the white point or flesh colors).

So one would like to apply a color transformation, so that on both displays approximately the same (or at least a more similar) color is reproduced, which ideally should be the color in the original (at least when the scene illumination has been discounted).

Since color vision in the early processing stages of human vision is a linear process, this can in theory be done (even for non-linear reproducers, since the non-linearities of the display can be taken into account in the model), and is in the linear light domain (e.g. XYZ, linear RGB) done by applying a matrix (so-called matrixing) to convert e.g. the RGB values of the camera, coming e.g. out of the cable (conversion to and from transmission color systems can be ignored for the present invention), into corrected RGB* values for the particular display.

There are however a number of reasons why color correction did not become so popular (i.e. no matrix or a theoretically incorrect matrix is used in the display).

Although one can with the knowledge of the physical behavior of a display (the actual light output of the different channels when the display is supplied with the display driving values R, G, B, and eventually for a multi-primary display further display driving values such as Ye (e.g. a value between 0 and 255 for yellow primary pixels)) have the display reproduce approximately (within a particular calibration accuracy, stability, etc.) the same colors as the standard intended television display, the reproduction of the colors in the original scene is at present unachievable.

One reason for this is that although display manufacturers know which display they build, the other side of the television chain, the recording side, has never been fully standardized, and is hence a variable which cannot be compensated for.

A cameraman may change e.g. the gamma transfer function shape determining parameters of his professional camera, or a color corrector may introduce unknown parameters, so that on the studio reproduction display used the colors of the scene look sufficiently realistic. What is a small difference on that display may however be a large difference on another display, in particular because displays have a usually nonlinear gamma characteristic, which may amplify small differences to large color differences.

There further being a number of uncontrollable variables at the reproduction side in the consumers location such has background lighting (and corresponding viewer adaptation), reflections on the display, etc., has lead to some people discarding color correction altogether, as the corrections may be smaller than the unknown variable errors.

Secondly there is a fundamental problem of gamut mapping, that two gamuts (e.g. a source gamut of the colors from a camera for a standard display, and an actual display gamut), although they may have many colors in common, always have some colors that can be reproduced in one but not the other gamut.

In particular, the change of white point is a known problem. A display with a natural white point which is too yellowish may need to reproduce a bluish white point (intended image rendering white point). Even for a display which can theoretically reproduce larger than 1 (or 255 or whatever the agreed maximum display driving value is) channel outputs (or relative channel luminance), like a CRT, the color system is so constructed that [1,1,1] corresponds to the maximum luminance color known as the (display) white.

For displays which work on the basis of selecting an amount of light to be outputted from a fixed light source (such as the backlight of an LCD display), light corresponding to display driving values higher than 1 can simply not be generated.

Therefore, in such a display there are three options:

a) display at least near whites (these being approximately achromatic colors of the highest luminance interval) with an incorrect chromaticity (e.g. too yellowish)
b) display near whites with a correct chromaticity, but clipped luminance
c) modify the luminances of at least the near white colors.

The third option when professionally done, can be realized with any of the many existing gamut mapping algorithms, however, because this is calculation intensive, in practical displays if anything is done at all, a matrix is used which maps the [1,1,1] input white to the white of maximally reproducible luminance of the desired chromaticity.

This has the disadvantage that all colors become unduly dark.

It is desirable to have a relatively simple method of color correction in a luminance direction for color transformation, which aims at mitigating luminance errors of colors, introduced by the transformation.

This can be achieved by a method comprising:
applying a color transformation (T) to an input color (Ci), yielding a transformed color (Ct);
determining a scaling factor (f) on the basis of a first display driving value representation (Rs,Gs,Bs) of the input color (Ci) and a second display driving value representation (Rt,Gt,Bt) of the transformed color (Ct); and
multiplying a color representation of the transformed color (Ct) with the scaling factor (f) to obtain an output color (Co).

Determining the maximum of the R, G, and B components of a color is an easy operation, in particular if the colors are already encoded in an RGB space, as is typical in a television system.

Although it is preferred to linearize as much as possible non-linear input color representations (e.g. by assuming a standard gamma of approximately 2.2, leaving at worst a smaller residue gamma), and to apply the transformation and correction method on a linearized RGB color representation, the method can also be applied in non-linear RGB color spaces.

The color transformation may be done in another color space than RGB also (e.g. XYZ, which may be interesting for computer and internet applications), as the multiplicative scaling works best in any linear color space, and can be applied approximately in any color space.

Note that the method is not restricted to a three-dimensional color space and may e.g. be used for a transformation of a 5 primary camera signal to a new 5-primary display.

The luminance information, and hence the error in the luminance of the transformed color, is implicitly present in the R, G, B values, hence a luminance correlate equation on the basis of these can be used to correct the luminance.

The invention is based on the insight that one only needs to check this luminance correlate for the input color and the resulting transformed color, and one can then simply correct the (typically) luminance reduction by rescaling.

Note that the simplest variants will just apply the per color determined fixed formula scaling factor for all colors. However, the scaling can also be made adaptive, e.g. on the basis of the magnitudes of the R, G and B values (e.g. the magnitude of the largest of them, named RGBmax in this text). In this way one can e.g. embody the method as to not scale dark colors (having small RGBmax values).

In an embodiment of the method, the determining a scaling factor (f) comprises determining the scaling factor on the basis of the maximal one of the display driving values of the first display driving value representation (Rs,Gs,Bs) and the maximal one of the display driving values of the second display driving value representation (Rt,Gt,Bt).

A reasonably accurate correlate of the luminance is the maximum of the three R, G, and B components, which will for bluish colors e.g. be the B component.

E.g. for standard display primary blue color reproduction, the input color will be [0,0,1] and hence the RGBmax (the maximal driving value of R, G and B) will be 1 (the value of the blue display driving value).

In a further embodiment, the determining a scaling factor (f) comprises determining the scaling factor as the maximal one of the display driving values of the first display driving value representation (Rs,Gs,Bs) divided by the maximal one of the display driving values of the second display driving value representation (Rt,Gt,Bt).

The simplest correction is just to divide the RGBmax values of the input and transformed RGB color. If e.g. the B value being the maximal value of the three driving values for a bluish color has dropped from 1 to 0.9 due to the matrixing (i.e. Bt=0.9*Bi, in which the index I indicates the input color, and t the matrix transformed color), the resulting decrease can be corrected by multiplying the transformed RGB values by 1/0.9, which is actually the division of the both RGBmax values.

The method functionality can be realized in a corresponding device for color correction in a luminance direction, comprising:
a color transformation unit (101), arranged to apply a color transformation (T) to an input color (Ci), yielding a transformed color (Ct);
a scaling factor determination unit (107), arranged to determine a scaling factor (f) on the basis of a first display driving value representation (Rs,Gs,Bs) of the input color (Ci) and a second display driving value representation (Rt,Gt,Bt) of the transformed color (Ct); and
a color scaling unit (109), arranged to multiplying a color representation of the transformed color (Ct) with the scaling factor (f) to obtain an output color (Co).

All method embodiments may be realized as correspondingly modified devices, having specially arranged units for realizing the further specified method steps. The method functionality can also be realized with a computer program product comprising code enabling a processor to execute steps of the method as claimed in claim 1, the steps being:
determining a scaling factor (f) on the basis of a first display driving value representation (Rs,Gs,Bs) of an input color (Ci) and a second display driving value representation (Rt,Gt,Bt) of a transformed color (Ct) resulting from applying a color transformation (T) to the input color (Ci); and
multiplying a color representation of the transformed color (Ct) with the scaling factor (f) to obtain an output color (Co).

This may be a software component e.g. a plug-in to function as or cooperate with e.g. a photo-retouching program running on a p.c. or consumer device such as a mobile phone. Note that the transformation may be realized within another software component or program. The computer program product will then typically comprise (possibly standardized) interface code to receive or fetch color data from before and after the transformation.

These and other aspects of the device and method for color correction according to the invention will be apparent from and elucidated with reference to the implementations and embodiments described hereinafter, and with reference to the accompanying drawings, which serve merely as non-limiting specific illustrations exemplifying the more general concept, and in which dashes are used to indicate that a component is optional, non-dashed components not necessarily being essential.

In the drawings:

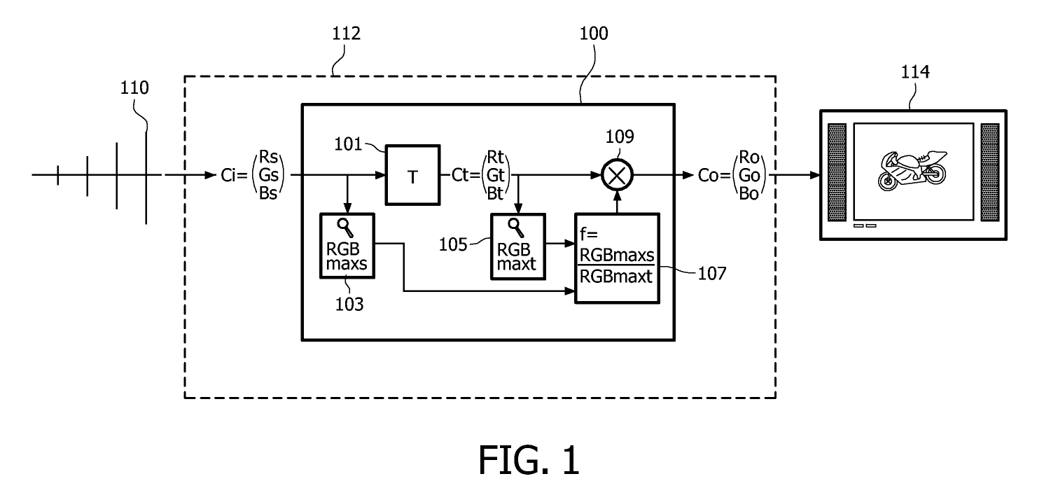

FIG. 1 schematically shows the device as embodied within a television signal receiver;

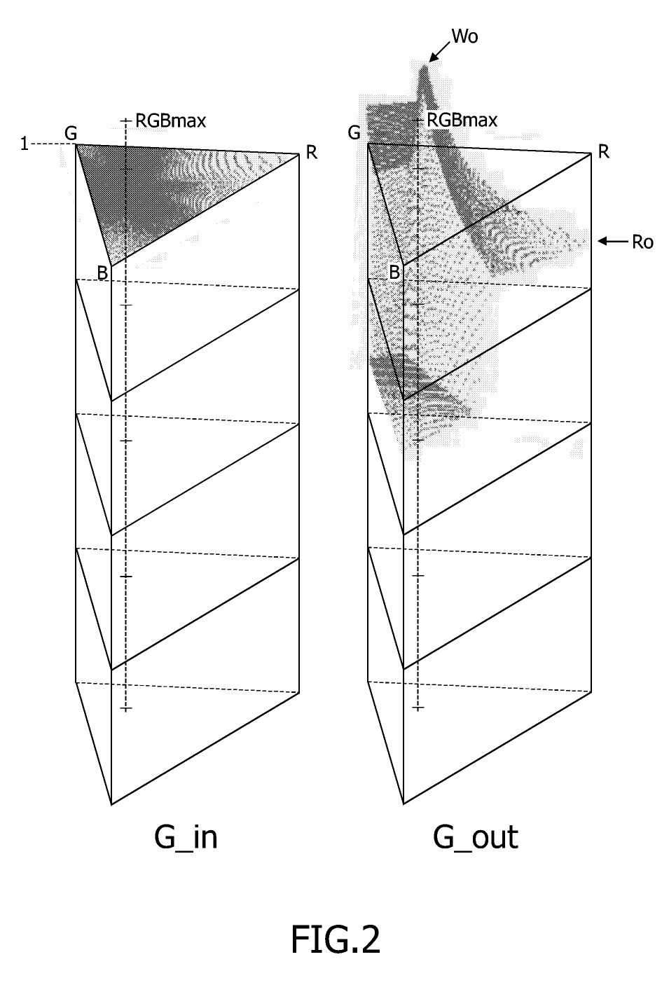

FIG. 2 schematically shows the effect of a particular color transformation in RGBmax space; and

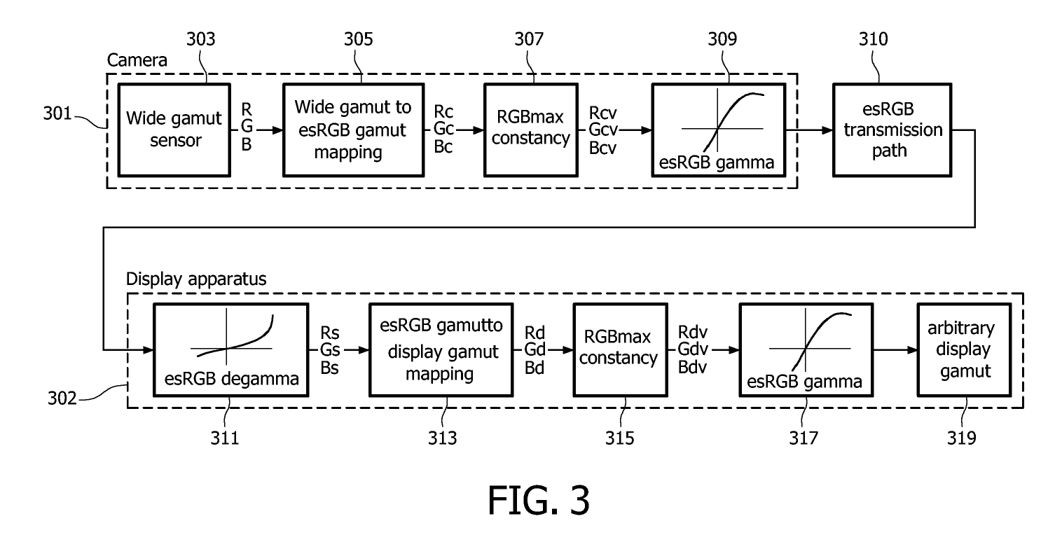

FIG. 3 schematically shows an exemplary color transmission chain, in which RGBmax is applied both on the camera side and on the display side.

In FIG. 1, a device 100 for color correction in a luminance direction is shown, which may be realized as e.g. a part of a dedicated video processing IC, or as a part of a PC running image processing software (e.g. preprocessing before face detection is performed in a security application). The device 100 receives at least one color from outside, and typically a number of color pixels from one or more color images.

A color transformation unit 101 is arranged to apply a color transformation, e.g. a matrixing between the input television colors Ci (originating from a camera or other capturing device such as a spectrometer), and required display driving values for accurately or reasonably faithful reproduction on an actual display (e.g. display 114 attached to television signal receiver 112):

$$( \begin{matrix}{R}_{t} \\ {G}_{t} \\ {B}_{t}\end{matrix} ) = ( \begin{matrix}a 11 & a 12 & a 13 \\ a 21 & a 22 & a 23 \\ a 31 & a 32 & a 33\end{matrix} ) ( \begin{matrix}{R}_{i} \\ {G}_{i} \\ {B}_{i}\end{matrix} ) \qquad [ Eq . 1 ]$$

Typically the input RGB values (index i) have been linearized as good as possible from their inverse gamma representations in the color transmission system, and the matrix coefficients may be such that correct chrominance and luminance is intended (i.e. if the driving values Rt etc. can actually be realized—which is impossible e.g. if they are negative, since negative light cannot be generated by a display—the color as intended on the “standard display” will be reproduced on the actual display 114).

Note that the color transformation can be any desired color transformation, linear (e.g. to obtain an intended, nearly correct color on a display with non-EBU primaries) or non-linear (e.g. with a gamut mapping strategy).

E.g. the matrix may incorporate a saturation, or colorfulness, etc. increase or decrease.

This way one can e.g. map to an enhanced gamut RGB (or even multiprimary) display with already increased saturation in the transformation, for optimal viewing quality according to some criterion. The present invention provides then a luminance improvement step.

Vice versa, colors may be mapped to a reduced gamma display, such as a portable LC, which may have additional reduction due to reflecting outside illumination, all of which can be taken into account in both the transformation and the luminance improvement post processing according to the present invention.

What the effect of such a transformation is, is shown in FIG. 2 in an RGBmax space. What is shown in this space is, for a number of selected colors (of all the possible to reproduce chromaticities and a particular luminance correlate), on the vertical axis the value of the maximal one of the R, G and B components (RGBmax).

As an input gamut G-in on the left each chromaticity has been reproduced with its maximum luminance, i.e. the RGBmax component is equal to one (e.g. for a red this corresponds to color [1,0,0] and for a yellow [1,1,0], etc.). This can also be seen as the reproduction without corrective matrixing, i.e. the chromaticities of the reproduced colors are incorrect.

After applying the color transformation of eq. 1 (G_out), one sees that the RGBmax of the colors have changed, and in a color dependent manner. E.g. the intended camera/standard display white Wo (e.g. D93 white) has now an RGBmax value larger than 1.

This will happen if one uses a matrix in which at least 1 of the sums of coefficients in a row is larger than 1. It may occur if e.g. the natural white point of the display 114 is too yellowish, and a compensating amount of blue above 1 is required to reproduce the D93 white of the same luminance (which is physically impossible on e.g. an LCD). Also one sees that the RGBmax of the red color Ro has gone down significantly. This may be due to several reasons, comprising, a lower contribution of the red component, because in the new primary system of the actual display 114 other primary contributions (green and/or blue) contribute to the luminance of the reproduced red color, and a lower contribution due to an overall reduction of the RGB driving values to be able to physically realize (with the maximum possible luminance on e.g. the LCD) the desired white point chromaticity.

But this means that an intended red color in the gamma G_in to be reproduced may actually be reproduced with too low a luminance, which is approximately corrected (mitigated) with the present device and method.

Thereto one can e.g. use the following exemplary very simple embodiment of FIG. 1, which can be generalized to other functions of the R, G, B coordinates of the inputted and transformed color.

A first maximum component calculator 103 is arranged to calculate the maximum value RGBmaxs of the inputted colors Ci. For the exemplary red color Ro the result will be the red component, yielding an RGBmaxs(Ro) equal to 1. A second maximum component calculator 105 similarly calculates the maximum value RGBmaxt of the transformed color Ct corresponding to each one of the inputted colors.

A scaling factor determination unit is arranged to determine the quotient of the two RGBmax values yielding a scaling factor f, and a color-scaling unit 109 (e.g. in this simple embodiment a multiplier) multiplies the three RGB components of the transformed color t with this scaling factor. In a linear color system, this has the effect that the chromaticity of the reproduced color remains the same (it was made correct by application of the color transformation T) but the luminance is changed to be more in correspondence with the original input luminance, i.e. of the (theoretical) input color Ci intended to be reproduced on the actual display 114.

In other words, the exemplary device 100 embodiment yields an output color Co intended to faithfully reproduce an input color Ci on the display 114, according to the following multiplicative equations:

$$f = \frac{max ( {R}_{s} , {G}_{s} , {B}_{s} )}{\begin{matrix}max ( {R}_{t} , {G}_{t} , {B}_{t} ) \\ ( \begin{matrix}{R}_{o} \\ {G}_{o} \\ {B}_{o}\end{matrix} ) = f ( \begin{matrix}{R}_{t} \\ {G}_{t} \\ {B}_{t}\end{matrix} )\end{matrix}} \qquad [ Esq . 2 ]$$

in which the index s indicates the inputted color Ci, t the transformed color Ct and o the output color, and the transformed color is derived from the inputted color with an equation like e.g. eq. 1.

This is mathematically a very easy operation (so e.g. useful for relatively cheap television ICs or generic processors which can only spare a limited amount of their resources for color processing). And one sees that one need not e.g. determine the exact matrix which scales the white to the maximum reproducible luminance value (with an RGBmaxo equal to 1), but rather any matrix which makes the chromaticities of the reproduced colors correct can be used, since Eq. 2 automatically makes the maximum reproducible white point.

The simple formula of Eq. 2 also needs no detailed knowledge of the display, i.e. it can always be applied. E.g., the display specific processing (the matrixing) can reside in one unit, and this post-correction can then always be applied (whatever the color transformation T).

The television signal receiver 112 may actually be embodied in different shapes, e.g. it may be a typical stand-alone television with built-in display, or a set-top-box, but it may also be an IC in a portable viewing device such as e.g. a mobile phone. The input signal is received from a television signal reception unit 110, e.g. a terrestrial television antenna coupled to receiving and decoding hardware or software (not shown), or an Internet connection, etc.

FIG. 3 shows an exemplary embodiment, in which also a camera 301 (in this example a wide gamut camera) applies RGBmax constancy (although other “standard” cameras may also apply it to undo their peculiarities, due to filters, processing, etc., and the application may be either in the camera or a separate post-processing device on the transmission side).

A wide gamut camera sensor 303 (e.g. a CCD) is able to generate colors in an extended range representation (extended standard RGB was proposed by the photographic and imaging manufacturers organization as a space which would cover also CRT-out-of-gamut colors in the printing and other colorant industries PIMA 7667:Working draft 1.0). esRGB thereto offers the possibility of encoding negative and overflow values.

Thereto a color transformation unit 305 is arranged to apply the transformation of whatever was measured (e.g. a spectrographic capture) to the esRGB specification. With such a standard transmission space, any color can device independently be reproduced, and then whatever color rendering device (image generation unit 319) can be attached on the receiver side.

As esRGb is still too limited for some gamut mapping scenarios (as was experimentally found), RGBmax application can help. Especially from going from a very wide gamut (triangle) to a very much smaller one has the effect that the maximum of the RGB components rises dramatically. This may be cumulative with having subsequently to view the image on a very small gamut display, such as the LCD of a portable apparatus. The resulting reproduction results in an untolerable amount of clipping, which may be wisely mitigated by applying the present RGBmax correction, preferably applied both on the camera (by RGBmax unit 307, operating according to the principle of Esq. 2) and display 302 side (by RGBmax unit 315, operating also according to the principle of Esq. 2, but now by taking into account what a color transformation unit 313 arranged to map to the gamut of the particular display has done).

Tone reproduction transformation units 309 and 315 are arranged to apply the gamma function specified in the esRGB standard to linear RGB values, and tone reproduction transformation unit 311, is arranged to apply the inverse of that gamma function.

Transmission path 310 can be anything known in the world of image transfer, such as e.g. a terrestrial television link, or other transmission means, or the transmission via storage on a DVD or other storage unit.

The present invention can be seen as a trade-off between luminance correctness (or at least a reasonable luminance combined with a reasonable chromaticity, which is always a difficult compromise) and algorithmic simplicity. Rather than absolute mathematical correctness (which for optimal precision would require information on surrounding illumination, viewer adaptation, etc.) television engineers are interested in algorithms that give good, realistic and pleasing results, which the present invention achieves by looking in a mathematically elegant way at what the reproduction capacity of the final display actually is, as well as at the intended source colors. An end customer prefers to have a display with both saturated and high luminance colors, which the present algorithm aims at achieving, i.e. not more light is sacrificed than necessary. At least the maximum components come out the algorithm as they went in. For primary colors, like primary red, this maximum is highly correlated with the color luminance. For intermediate colors this is only approximately true, but e.g. in a facial color at least its red dominant contribution is approximately corrected.

The RGBmax correction is preferably applied at the end of the colorimetric chain (saturation processing, white point correction, etc.), although this is not strictly necessary.

The algorithmic components disclosed in this text may in practice be (entirely or in part) realized as hardware (e.g. parts of an application specific IC) or as software running on a special digital signal processor, or a generic processor, etc.

This software may be embodied as a computer program product, which should be understood any physical realization of a collection of commands enabling a processor—generic or special purpose—, after a series of loading steps (which may include intermediate conversion steps, like translation to an intermediate language, and a final processor language) to get the commands into the processor, to execute any of the characteristic functions of an invention. In particular, the computer program product may be realized as data on a carrier such as e.g. a disk or tape, data present in a memory, data traveling over a network connection—wired or wireless—, or program code on paper. Apart from program code, characteristic data required for the program may also be embodied as a computer program product.

Some of the steps required for the working of the method may be already present in the functionality of the processor instead of described in the computer program product, such as data input and output steps.

It should be noted that the above-mentioned embodiments illustrate rather than limit the invention. Apart from combinations of elements of the invention as combined in the claims, other combinations of the elements are possible. Any combination of elements can be realized in a single dedicated element.

Any reference sign between parentheses in the claim is not intended for limiting the claim. The word “comprising” does not exclude the presence of elements or aspects not listed in a claim. The word “a” or “an” preceding an element does not exclude the presence of a plurality of such elements.

1. A method of color correction in a luminance direction, comprising:
applying a color transformation (T) to an input color (Ci) defined with respect to put primaries to yield a transformed color (Ct) defined with respect to display primaries, wherein the display primaries form a primary system different than the primary system formed by the input primaries;
determining a scaling factor (f) on the basis of a first display driving value representation (Rs,Gs,Bs) of the input color (Ci) and a second display driving value representation (Rt,Gt,Bt) of the transformed color (Ct); and
multiplying a color representation of the transformed color (Ct) with the scaling factor (f) to obtain an output color (Co).

2. A method of color correction in a luminance direction as claimed in claim 1, in which the determining a scaling factor (f) comprises determining the scaling factor on the basis of the maximal one of the display driving values of the first display driving value representation (Rs,Gs,Bs) and the maximal one of the display driving values of the second display driving value representation (Rt,Gt,Bt).

3. A method of color correction in a luminance direction as claimed in claim 2, in which the determining a scaling factor (f) comprises determining the scaling factor as the maximal one of the display driving values of the first display driving value representation (Rs,Gs,Bs) divided by the maximal one of the display driving values of the second display driving value representation (Rt,Gt,Bt).

4. A method of color correction in a luminance direction as claimed in claim 1, in which the applying a color transformation (T) is performed in a display driving value representation.

5. A device (100) for color correction in a luminance direction, comprising:
a color transformation unit (101), arranged to apply a color transformation (T) to an input color (Ci) defined with respect to input primaries to yield a transformed color (Ct) defined with respect to display primaries, wherein the display primaries form a primary system different than the primary system formed by the input primaries;
a scaling factor determination unit (107), arranged to determine a scaling factor (f) on the basis of a first display driving value representation (Rs,Gs,Bs) of the input color (Ci) and a second display driving value representation (Rt,Gt,Bt) of the transformed color (Ct); and
a color scaling unit (109), arranged to multiplying a color representation of the transformed color (Ct) with the scaling factor (f) to obtain an output color (Co).

6. A device (100) for color correction in a luminance direction as claimed in claim 5, in which the scaling factor determination unit (107) is arranged to determine the scaling factor (f) as the maximal one of the display driving values of the first display driving value representation (Rs,Gs,Bs) divided by the maximal one of the display driving values of the second display driving value representation (Rt,Gt,Bt).

7. A television signal receiver (112) comprising a television signal reception unit (110) and a device (100) as claimed in claim 5.

8. A camera (301) comprising an image-capturing device (303) arranged to supply colors to a device (100) as claimed in claim 5.

9. A computer program product comprising code enabling a processor to execute steps of the method as claimed in claim 1, the steps being:
determining a scaling factor (f) on the basis of a first display driving value representation (Rs,Gs,Bs) of an input color (Ci) and a second display driving value representation (Rt,Gt,Bt) of a transformed color (Ct) resulting from applying a color transformation (T) to the input color (Ci); and
multiplying a color representation of the transformed color (Ct) with the scaling factor (f) to obtain an output color (Co).
